(19) United States
(12) Patent Application Publication
(10) Pub. No.: US 2011/0011613 A1
(43) Pub. Date: Jan. 20, 2011

(54) TREATED ELECTRICAL CONDUIT

(75) Inventors: Clifford Eugene Brown, JR., Apollo Beach, FL (US); Robert Pereira, Rochester, MA (US)

Correspondence Address: Tyco International Management Corp., 9 Roszel Road, Princeton, NJ, 08540, US

(73) Assignee: WPFY, INC., Wilmington, DE (US)

(21) Appl. No.: 12/505,681

(22) Filed: Jul. 20, 2009

(51) Int. Cl. H02G 3/04; H01B 9/02; H01R 43/00

(52) U.S. Cl. 174/68.3; 174/107; 29/825

(57) ABSTRACT

An improved electrical conduit having a protective material thereon for anti-microbial and antifungal prevention. The metallic conduit includes a metal armor defining an outer surface and an interior hollow area within which electrical conductors are disposed. A first polymeric layer is formed over the outer surface of the metal armor. A second polymeric layer is extruded over the first polymeric layer. The first and/or second polymeric layers may be formed with an anti-microbial and/or anti-fungal additive. In addition, the first polymeric layer may have a first color and the second polymeric layer may have a second color where the first color is different from the second layer sufficient for the first color to be visible when the second polymeric layer is compromised.

### BACKGROUND OF THE INVENTION

1. Field of the Invention

Embodiments of the invention relate to the field of cables and conduit. More particularly, the present invention relates to improved cables and conduit employing a protective material thereon for anti-microbial, antifungal, anti-mildew and antiviral prevention.

2. Discussion of Related Art

In the construction industry, electrical wires or conductors are often run through various structures to safely deliver power to and from a panel and then onto different areas of a building or underground to additional structures. These conductors may be protected from the environment by a metal or polymeric outer sheathing. Generally, conduit refers to a flexible or rigid protective metal armor or polymeric sheath in which the electrical conductors are pulled through after the conduit is installed in a desired location. Conversely, cable refers to a metallic or polymeric armored flexible sheath which is wrapped around the electrical conductors or cable during manufacture. Conduit comes in a variety of sizes to house different types of conductors and cables standard to the electrical industry to satisfy building codes as set forth, for example in the National Electric Codes (NEC®). Various types of conduit may be used for power, process, communications uses as well as for installation indoors and outdoors. Conduit may also be configured to provide moisture, chemical, heat and impact protection for the electrical conductors installed therein. For example, conduit may be used in factories and processing plants in which highly corrosive materials and chemicals are used which may compromise the electrical characteristics of exposed conductors. In addition, certain conduit may be used in high temperature environments as well as used in locations where flame retardant and UV resistant characteristics are required. Although rigid conduit, sometimes referred to as pipe, which is a continuous length of sheet metal which is seam welded, has a particular thickness and composition, flexible conduit is more frequently used in residential and commercial wiring applications because of the versatility imparted by its mechanical protection, flexible nature, and resistance to environmental elements.

Flexible conduit formed by helically winding a continuous strip of metal generally steel or aluminum and mechanically interlocking the edges to form a protective armor. In addition there are polymeric alternatives of flexible conduit that offer a protective armor over the conductors. When installed, the flexible conduit is supplied from a coil or reel and cut to appropriate lengths. Electrical conductors or cables are then pulled through the installed conduit to provide power within the structure for various applications. The ends of the conduit are attached to electrical function) boxes and connections are made among the conductors within the boxes as well as to electrical fixtures. In this manner, the conduit provides mechanical protection of the electrical conductors while enabling them to be bent around corners and the like for relatively easy and fast installation.

For certain applications, conduit may be manufactured to accommodate various wiring applications indoors and outdoors, in wet or damp locations, for direct burial and concrete embedment installations as well as other locations where moisture resistance is required. In such applications, a polymeric jacket is provided over the flexible steel sheathing. This polymer may be, for example, polyvinylchloride (PVC), thermoplastic polyurethane (TPU) as well as other thermoplastic materials. However, the polymeric jacket provided over the armor does not indicate when the protective jacket has been compromised thereby potentially compromising the liquid tight properties of the conduit, the protective metal armor and/or the electrical conductors contained within the conduit. Present conduit does not provide a means to rapidly and easily indicate when such a compromise has occurred. In addition, conduit may be installed in hospitals, nursing homes and other healthcare facilities where they are susceptible to providing environments where certain fungi and microbes may proliferate. Present designs do not provide antifungal and/or antimicrobial properties for installed conduit. Thus, there is a need for conduit designed to overcome the deficiencies of present configurations.

### SUMMARY OF THE INVENTION

Exemplary embodiments of the present invention are directed to electrical conduits. In a first exemplary embodiment, an electrical conduit includes a flexible steel tubular structure having an outer armor and an interior hollow area. A first polymeric layer having a first color is disposed on the outer sheathing. A second polymeric layer having a different color than the first polymeric layer is disposed on the first polymeric layer such that the first layer is visible when the second layer is compromised. The first and second polymeric layers are configured to prevent ingress of liquid within the conduit

In another exemplary embodiment, an electrical conduit includes a flexible metal tubular structure having an outer armor defining an interior hollow area. A polymer is treated with an antifungal and/or an antimicrobial material and is extruded over the metal armor.

In another embodiment, a coextruded polymeric hose having a defined flexible outer surface is treated with an antifungal and /or an antimicrobial material which encapsulates a rigid polymeric core, defined with an interior hollow area configured to house one or more electrical conductors or cables.

In another embodiment, a corrugated polymeric tubular structure is treated with an antifungal and /or an antimicrobial material. The corrugated tubular structure has an outer surface and an interior hollow area configured to house one or more electrical conductors or cables.

### BRIEF DESCRIPTION OF THE DRAWINGS

FIG. 1 is a perspective cut-away view of an exemplary conduit in accordance with the present invention.

FIG. 1A is a cross sectional view of an exemplary conduit in accordance with the present invention.

FIG. 2 is a flow chart illustrating a process of manufacturing an exemplary conduit in accordance with an embodiment of the present invention.

FIG. 3 is a cut-away perspective view of a portion of an exemplary non-metallic conduit in accordance with an embodiment of the present invention.

FIG. 4 is a side view of an exemplary metallic conduit in accordance with an embodiment of the present invention

FIG. 5 is a cut-away perspective view of a non-metallic corrugated polymeric tube in accordance with an embodiment of the present invention.

### DESCRIPTION OF EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

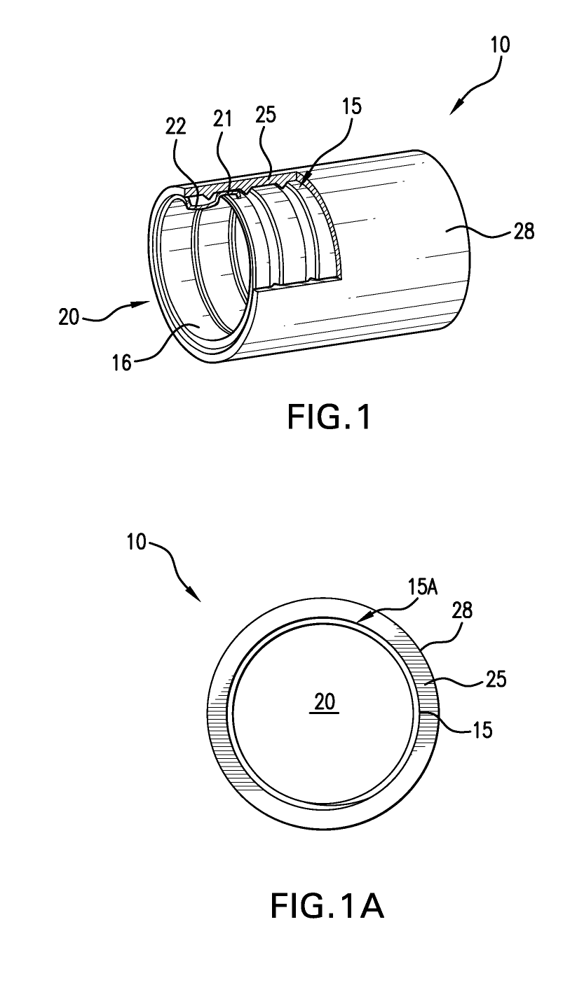

FIG. 1 is a perspective cut-away view of an exemplary conduit 10 having a metallic armor 15 defining an inner hollow area 20 which runs the length of the conduit. The conduit forms a raceway for the installation of electrical conductors or wires which are disposed in hollow area 20. Exemplary conduit 10 is formed from interlocking sections 16 of arcuate members which present a continuous surface of alternating crowns 21 and troughs 22 on both the exterior and interior walls thereof to form a strong, bendable conduit. The plurality of windings 16 are formed from a helically interlocked continuous strip of steel, aluminum or alternative materials having a generally “square” shape. Troughs 22 may form spaces separating each of the windings 16. Certain types of conduit may be used in corrosive environments such as processing plants where the electrical conductors are protected from various liquids and other harmful elements (e.g. chemicals) that may compromise the electrical characteristics of the conductors. Conduit 10 may also be made from heavier grades of steel, aluminum or other metals for exposed conduit installations where increased crush and/or impact resistance is needed while thin walled conduit may only be suitable for hidden or less trafficked areas or in areas with less potential for damage. Aluminum may be used for applications that allow for lighter weight armor sheathing as compared to similarly sized steel conduit.

In particular applications and installations, conduit 10 may be required to be liquidtight thereby preventing liquids from penetrating into hollow area 20. With reference to both FIGS. 1 and 1A which is a cross sectional view of conduit 10 shown in FIG. 1, protective armor 15 is surrounded by one or more layers of polymeric material extruded around the outer surface thereof. In particular, a first layer of polymer 25 is extruded over an outer surface 15A of outer sheath 15. A second layer 28 is extruded over first layer 25. The polymeric material may be, for example, polyvinylchloride (PVC), thermoplastic polyurethane (TPU) or other thermoplastics. Although layers 25 and 28 are illustrated as having particular thicknesses, this is for explanatory purposes only and the respective thicknesses of each layer may vary depending on the desired application. The extruded polymeric layers 25, 28 provide a liquid tight environment for the electrical conductors housed in the hollow area 20 of conduit 10.

A typical extrusion process in which the polymeric layers 25 and 28 are disposed around the outer surface 15A of sheathing 15 includes heating a polymer to enable extrusion of the polymer through a form or die onto the sheathing 15. In particular, pellet forms of a polymer are placed in a cylindrical chamber and then conveyed forward by the rotation of a profiled screw within the cylindrical cylinder which is often referred to as a barrel. The barrel may be heated gradually along the length of the barrel such that the material melts gradually to avoid overheating and degrading the particular polymeric polymer. As the screw turns inside the barrel, intense pressure and friction is created as the polymeric pellets are pushed along the length of the barrel toward a die positioned at one end. The die provides the polymer with the desired profile for extrusion over the outer surface of the protective armor 15. The first layer 25 shown in FIG. 1 has a particular color which is different from the color of second layer 28. This is obtained by adding a dye to the resin in the hopper or may be added to the pellets themselves during a previous extrusion process. To obtain the dual layer configuration, the first layer 25 is extruded onto the outer surface 15A of sheath 15 through the use of one extruder using the particular colored dye and the second layer 28 having a different color is extruded over layer 25 using a second extruder. Alternatively, both layers 25 and 28 may be co-extruded simultaneously to form an integral jacket over the outer surface 15A of sheath 15. The use of a colored first layer 25 provides indicia when second layer 28 has been compromised. In particular, when second layer 28 is nicked, cut or damaged, it is difficult to locate the damaged location along the length of the conduit. In addition, this damaged location may spread across a larger area along the length of the conduit. By using a first layer 25 having a different color (e.g. yellow) than the second layer 28, this damaged area is easily identified and may be repaired before the conductors are compromised

Layers 25 and/or 28 may be treated with an antifungal and/or an antimicrobial additive. As mentioned earlier, conduit 10 may be installed in hospitals, nursing homes or other healthcare facilities. An anti-fungal additive prevents the formation of these contaminants on and within conduit 10 especially in the liquidtight environment. Typical fungi that may be problematic in these environments where conduit is installed include, for example, Aspergillus Niger (commonly referred to as black mold), Cladosporidium (common indoor/outdoor molds) and Aureobasidium (commonly isolated from plant debris). In addition, an anti-microbial additive as described below may be introduced (alternatively or in addition to the antifungal additive) into the first layer 25 and/or second layer 28 which is volumetrically blended with the polymer when the polymeric is introduced to heat within the extruder. Once the extruded polymer is cured, conduit 10 exhibits antimicrobial properties.

There are various configurations of layers 25 and 28 having either or both the antifungal and/or antimicrobial additives depending on the particular application and installation environment for conduit 10. For example, in one embodiment first layer 25 and second layer 28 may each be formed with both an antifungal and antimicrobial additive where first layer 25 is formed with an antifungal additive and an antimicrobial additive and second layer 28 is also formed with an antifungal and an antimicrobial additive. In another embodiment, only the second layer 28 is formed with an antifungal and an antimicrobial additive and first layer 25 is formed without either additive. In another embodiment, second layer 28 is formed with an antifungal or an antimicrobial additive. In another embodiment, first layer 25 is formed with an antifungal additive and the second layer 28 is formed with both an antifungal and antimicrobial additive. In another embodiment, first layer 25 is formed with an antifungal additive and the second layer 28 is formed with an antifungal additive. In another embodiment, first layer 25 is formed with an antifungal additive and the second layer 28 is formed with an antimicrobial additive. In another embodiment, first layer 25 is formed with an antimicrobial additive and the second layer 28 is formed with both an antifungal and antimicrobial additive. In another embodiment, first layer 25 is formed with an antimicrobial additive and the second layer 28 is formed with an antifungal additive. In another embodiment, first layer 25 is formed with an antimicrobial additive and second layer 28 is also formed with an antimicrobial additive. For each of the foregoing embodiments, first layer 25 may be formed with a different color as compared with second layer 28 or each layer may have the same color.

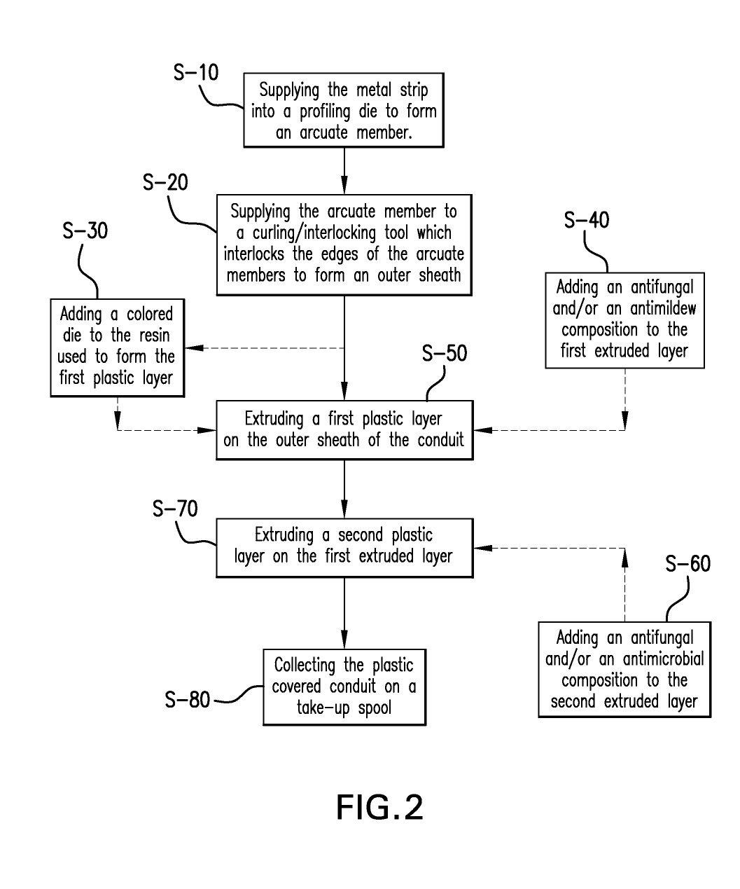

FIG. 2 is an exemplary flow chart illustrating a method of manufacturing conduit 10 having a plurality of extruded surrounding polymer layers. In particular, a steel strip is fed from a supply coil into a profiling die which forms the strip into an arcuate members at step S-10. As noted above, the arcuate members may, for example, have a ‘S’ or ‘Z’ shape. The arcuate members are then supplied to a curling/interlocking tool which interlocks the edges of the arcuate members to form an outer sheath 15 at step S-20. The hollow area 20 within the outer sheath 15 forms the raceway through which electrical conductors are pulled. At step S-30, a colored dye may be added to the pellets used to form first polymeric layer 25. In addition or alternatively, an anti-fungal composition may also be added to the polymeric pellets used to form first extruded layer 25 at step S-40. Alternatively, the anti-fungal additive may be pre-blended with the polymeric pellets during extrusion of the first layer 25. The antifungal additive may be, for example, Vinyzene BP5-2 & Vinyzene DCOIT available from Rohm and Haas, Polymeric Additives Group subsidiary of The Dow Chemical Group Also at step S-40, an antimicrobial additive may also be added to the polymeric pellets or may be pre-blended in the pellets when forming first layer 25. An exemplary antimicrobial material is available from SteriTouch Ltd., and has the product name MXO-19690. This additive has been found to provide sufficient anti-microbial protection against, for example, MRSA (Methicillin-Resistant Staphylococcus Aureus). At step S-50, the first polymeric layer 25 is extruded on the outer surface 15A of sheath 15 of conduit 10. Again, the antifungal and/or the anti-microbial additive may be added to or preblended with the pellets used to form the second extruded layer 28 at step S-60. This anti-microbial material is an inorganic antibacterial product in a universal carrier and may be in pellet form. This material is supplied to the extruder hopper with the polymeric pellets at approximately 2% by volume weight. Because the protected conduit 10 may be used in a liquid tight environment, the antimicrobial protectant present in first layer 25 and/or second layer 28 prevents unwanted microbials such as viruses from existing on or within the protective polymeric layer. At step S-70, a second polymeric layer is extruded on the first extruded layer. The conduit is then collected on a take-up spool at step S-80.

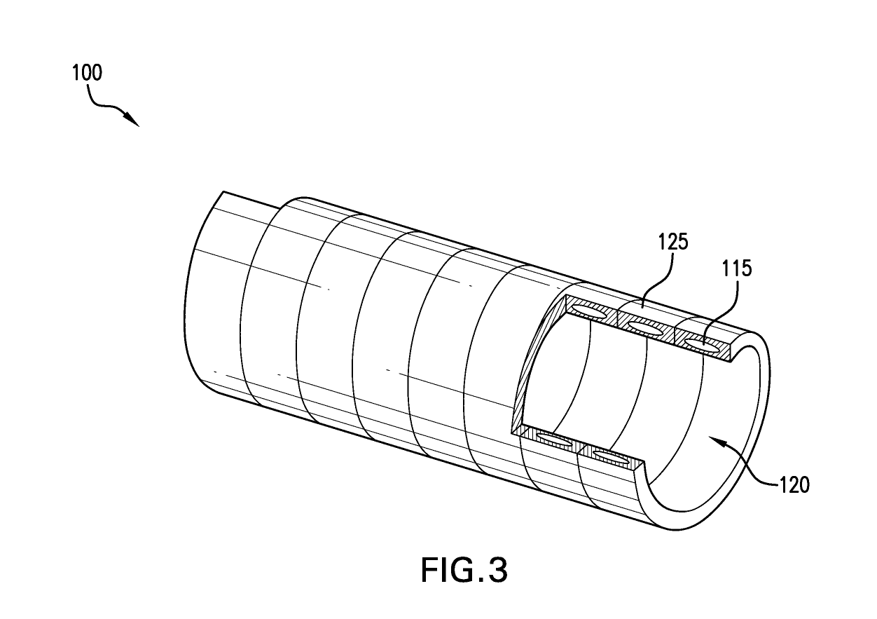

FIG. 3 is a cut-away perspective view of a portion of an exemplary non metallic liquidtight conduit or helix 100 having a flexible layer 125 defining a hollow area 120 within which electrical conductors are disposed. Conduit 100 includes a rigid polymeric inner portions 115 having, for example an oval shape (e.g. oval) which is encapsulated by layer 125. The polymeric used to form inner rigid portions 115 may be PVC and may be extruded with a reinforcing member and/or have a corrugated profile to add strength and rigidity to conduit 100. The flexible layer 125 may also be made from PVC where the inner rigid portions 115 and layer 125 are co-extruded and wound upon a mandrel to provide the desired cross-section. Layer 125 may be formed with an antifungal and/or antimicrobial additive depending on the particular application and installation environment for the conduit. In particular, layer 125 may be extruded with an antifungal additive such as, for example, Vinyzene BP5-2 & Vinyzene DCOIT available from Rohm and Haas, Polymeric Additives Group subsidiary of The Dow Chemical Group. Similar to the extrusion process described above with reference to FIGS. 1-2, the anti-fungal additive may be pre-blended with the polymeric pellets or added to the hopper during the extrusion process when forming flexible layer 125. Layer 125 may be extruded with an antimicrobial additive such as, for example, product name MXO-19690 available from SteriTouch Ltd. This antimicrobial additive may be pre-blended with the polymeric pellets or added to the hopper during the extrusion process when forming flexible layer 125 with the rigid portions 115. Alternatively, both the antimicrobial and antifungal additives may be added to or pre-blended with the polymeric pellets used to extrude layer 125. In this manner, a non-metallic liquidtight conduit is formed that has antifungal and/or antimicrobial properties.

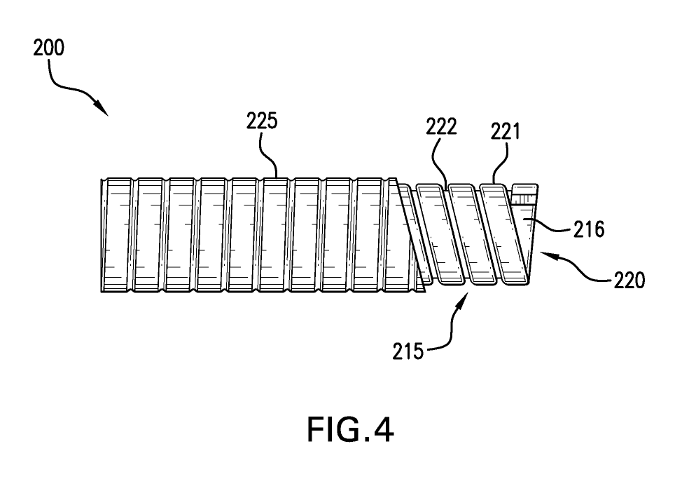

FIG. 4 is a side cut-away view of a portion of an exemplary conduit 200 having a steel sheathing 215 defining an inner hollow area 220 which runs the length of the conduit. The conduit forms a raceway for the installation of electrical conductors or wires which are disposed in hollow area 220. Similar to the conduit described with reference to FIG. 1, conduit 200 is formed from interlocking sections 216 of arcuate members which present a continuous surface of alternating crowns 221 and troughs 222 on both the exterior and interior walls thereof to form a strong, bendable conduit. The arcuate members of sheath 215 are formed from a strip of steel which is helically wound the edges of which are interlocked. Sheathing 215 is surrounded by a polymeric layer 225 extruded around the outer surface thereof to provide liquidtight performance properties for the electrical conductors housed in hollow area 220 of conduit 20. The polymeric material may be, for example, polyvinylchloride (PVC), thermoplastic polyurethane (TPU) or other thermoplastics. Polymeric layer 225 is formed around sheathing 215 with an antifungal and/or an antimicrobial additive. As mentioned earlier, an anti-fungal additive such as, for example, Vinyzene BP5-2 & Vinyzene DCOIT available from Rohm and Haas Canada, LP, prevents the formation of these contaminants on and within the polymeric layer 200. In addition or alternatively, polymeric layer 225 may be formed with an anti-microbial additive such as, for example, MXO-19690 available from SteriTouch Ltd., to prevent the microbial formation on or within conduit 200. The antifungal and/or antimicrobial materials may be added to the polymer pellets during extrusion of polymeric layer 225 around sheathing 215 and/or may be pre-blended with the pellets prior to extrusion. In this manner, a flexible liquidtight steel conduit is formed that has antifungal and/or antimicrobial properties.

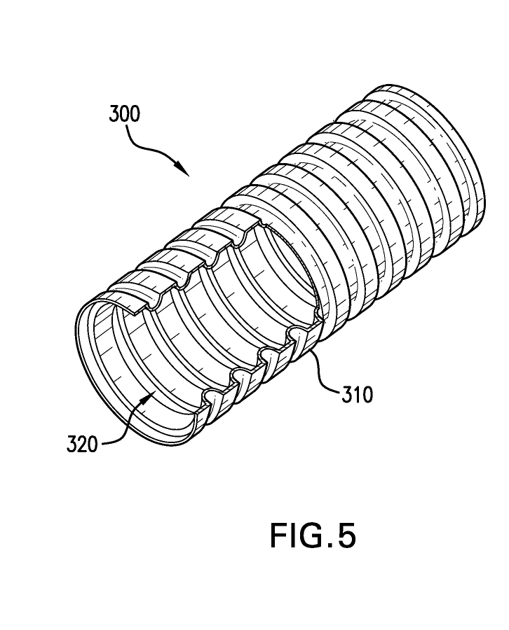

FIG. 5 is a cut-away prospective view of a non-metallic corrugated polymeric tube 300 defining an inner hollow area 320 within which electrical conductors or cables are disposed. Tube 300 has a corrugated outer surface 310 defining the hollow area 320. Tube 300 may also be formed with multiple layer, for example, having a smooth inner layer co-extruded with the outer surface 310. The polymeric used to form the corrugated tube 300 may be PVC and is formed with an antifungal and/or antimicrobial additive depending on the particular application and installation environment for the corrugated tube. In particular, corrugated tube 300 may be formed with an antifungal additive such as, for example, Vinyzene BP5-2 & Vinyzene DCOIT available from Rohm and Haas, Polymeric Additives Group subsidiary of The Dow Chemical Group. Similar to the extrusion process described above, the anti-fungal additive may be pre-blended with the polymeric pellets or added to the hopper during the extrusion process. Corrugated tube 300 may be formed with an antimicrobial additive such as, for example, product name MXO-19690 available from SteriTouch Ltd. This antimicrobial additive may be pre-blended with the polymeric pellets or added to the hopper during the extrusion process when forming tube 300. Alternatively, both the antimicrobial and antifungal additives may be added to or pre-blended with the polymeric pellets used to form tube 300. In this manner, a non-metallic corrugated tube is formed that has antifungal and/or antimicrobial properties.

While the present invention has been disclosed with reference to certain embodiments, numerous modifications, alterations and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. An electrical conduit comprising:
a flexible metal armor having an outer surface and defining an interior hollow area, said inner hollow area configured to house one or more electrical conductors;
a first polymeric layer disposed on said outer surface of said flexible metal sheathing, said first layer having a first color; and
a second polymeric layer disposed on said first polymeric layer, said second layer having a different color than said first layer such that said first layer is visible when said second layer is compromised, said first and second polymeric layers configured to prevent ingress of liquid within said conduit.

2. The electrical conduit of claim 1 wherein the flexible metal tubular structure comprises a steel composition.

3. The electrical conduit of claim 1 wherein said flexible metal tubular structure comprises a metal strip helically wound with interlocking edges.

4. The electrical conduit of claim 1 wherein said first polymeric layer is extruded with an anti-fungal material.

5. The electrical conduit of claim 1 wherein said second polymeric layer is extruded with an anti-fungal material.

6. The electrical conduit of claim 1 wherein said first polymeric layer is extruded with an anti-microbial material.

7. The electrical conduit of claim 1 wherein said second polymeric layer is extruded with an anti-microbial material.

8 An electrical conduit comprising:
a flexible metal armor having an outer surface and defining an interior hollow area, said inner hollow area configured to house one or more electrical conductors;
a first polymeric layer disposed on said outer surface of said flexible metal armor, said first layer having a first color; and
a second polymeric layer disposed on said first polymeric layer such that said first and second polymeric layers are configured to prevent ingress of liquid within said conduit, said second polymeric layer is extruded with an anti-microbial additive.

9. The electrical conduit of claim 8 wherein said flexible metal tubular structure comprises a metal strip helically wound with interlocking edges.

10. The electrical conduit of claim 8 wherein said first polymeric layer includes an anti-microbial additive.

11. The electrical conduit of claim 8 wherein said first polymeric layer includes an anti-fungal additive.

12. The electrical conduit of claim 8 wherein said second polymeric layer includes an anti-fungal additive.

13. An electrical conduit comprising:
a polymeric rigid helix defining an outer surface and an interior hollow area, said interior hollow area extending longitudinally the length of said conduit and configured to house one or more electrical conductors; and
a substantially flexible polymeric layer disposed on said outer surface of said polymeric helix, said flexible polymeric layer having an anti-microbial additive.

14. The electrical conduit of claim 13 wherein said flexible polymeric layer includes an antifungal additive.

15. A method of manufacturing an electrical conduit comprising:
supplying a metal strip into a profiling die to form arcuate members;
supplying the arcuate members to an interlocking tool configured to interlock the respective edges of the arcuate members to form an outer armor;
forming a first polymeric layer having a first color over said outer armor; and
forming a second polymeric layer on the first polymeric layer, said second polymeric layer having a second color different from said first color.

16. The method of manufacturing electrical conduit of claim 15 further comprising adding an anti-fungal composition to the first polymeric layer.

17. The method of manufacturing electrical conduit of claim 15 further comprising adding an anti-fungal composition to the second polymeric layer

18. The method of manufacturing electrical conduit of claim 15 further comprising adding anti-microbial protection to the first polymeric layer.

19. The method of manufacturing electrical conduit of claim 15 further comprising adding anti-microbial protection to the second polymeric layer.

20. A method of manufacturing an electrical conduit comprising:
supplying a metal strip into a profiling die to form a plurality of arcuate members;
supplying each arcuate member to an interlocking tool configured to interlock the respective edges of the arcuate members to form an outer armor having an outer surface and an interior hollow area; and
forming a polymeric layer over said outer surface of said protective armor wherein said polymeric layer is formed with an anti-microbial additive.

21. The method of manufacturing an electrical conduit of claim 20 wherein said polymeric layer is formed with an antifungal additive.

22. An electrical conduit comprising:
a flexible polymeric tube having a corrugated outer surface and a smooth or corrugated inner surface, said inner surface defining an interior hollow area configured to house one or more electrical conductors, said flexible polymeric having an antimicrobial additive.

23. An electrical conduit comprising:
a flexible polymeric tube having a corrugated outer surface and a smooth or corrugated inner surface, said inner surface defining an interior hollow area configured to house one or more electrical conductors, said flexible polymeric having an antifungal additive.
